(19) United States
(12) Patent Application Publication
(10) Pub. No.: US 2008/0023877 A1
(43) Pub. Date: Jan. 31, 2008

(54) METHOD OF INJECTION MOLDING

(75) Inventors: Jeremy King, Duncan, SC (US); William Ryan, Farmington Hills, MI (US); Chris Hathaway, Dixmont, ME (US)

Correspondence Address: GIFFORD, KRASS, SPRINKLE,ANDERSON & CITKOWSKI, P.C, PO BOX 7021, TROY, MI, 48007-7021, US

(73) Assignee: Z F Group North American Operations, Inc., Northville, MI (US)

(21) Appl. No.: 11/830,296

(22) Filed: Jul. 30, 2007

Related U.S. Application Data
(60) Provisional application No. 60/834,127, filed on Jul. 28, 2006.

(51) Int. Cl. B29C 70/70

(52) U.S. Cl. 264/241

(57) ABSTRACT

An in-place method for molding a part includes positioning an insert in an injection mold cavity and injecting molding material around the insert to form a part which includes the molded part and the insert.

### CROSS-REFERENCE TO RELATED APPLICATIONS

This application claims priority of U.S. Provisional Patent Application Ser. No. 60/834,127 filed Jul. 28, 2006, which is incorporated herein by reference.

### FIELD OF THE INVENTION

The present concerns a method for in-place injection molding. More specifically, the invention concerns a method for molding a part in which an insert may be positioned into an injection mold cavity. Moldable material may then be injected into the cavity and around the insert such that, upon completion of a mold operation, a completed part may include at least a molded portion and the insert.

### REFERENCE TO RELATED ART

Prior art methods for molding certain apparatus required that an injected molded portion of a larger part assembly be manufactured in a separate mold cavity. Thereafter, the molded portion must be integrated into the larger assembly. However, in some cases, the larger assembly (such a housing for the molded portion), must itself be manufactured in multiple pieces so that it properly contains and/or supports the molded portion. Therefore, it would be advantageous to have an in-place molding method that does not require separate molding and then assembly of the finished part.

### BRIEF DESCRIPTION OF THE DRAWINGS

Reference will now be had to the attached drawings wherein like reference numerals refer to like parts throughout and wherein:

FIG. 1 is a side cutaway view showing an assembly for practicing the method of the present invention.

### DETAILED DESCRIPTION OF THE PREFERRED EMBODIMENTS

In one embodiment of the method of the present invention, there may be provided a mold that includes a first and second mold section, which together may define a mold cavity. The mold cavity may be shaped to removably accept a part insert (for example a housing for a ball joint). The mold cavity may also be constructed such that when sealed a space may be defined around the insert to receive injectable moldable material. Further, one or more ports may be provided in at least one mold section that lead to the space(s) provided in the cavity. Accordingly, injectable moldable material may be caused to flow through the injection ports into the open space(s) where the material may then solidify around the insert. Thereafter, a part that includes the insert and associated molded portion may be removed from the mold cavity.

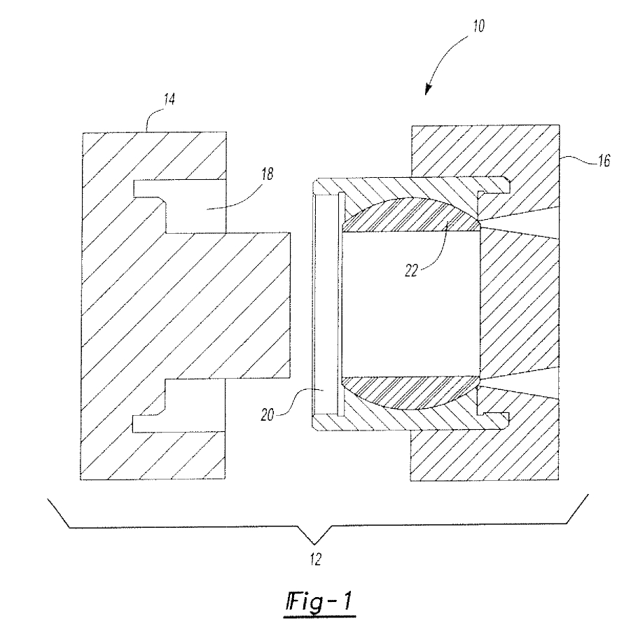

Referring now to FIG. 1, a method 10 of injection molding may include providing a mold body 12 that may have an upper 14 and a lower 16 mold section. The upper 14 and lower 16 mold sections may define a mold cavity 18 into which an insert 20 may be removably positioned. The mold cavity 18 may also be constructed such that when the mold body 12 is sealed, one or more spaces 22 may be defined around the insert 20 to receive injectable moldable material. Further, at least one of the mold section 14, 16 may include an injection port(s) 22 to receive and transmit a moldable material into the spaces 22 of the mold cavity 18.

It will be appreciated that where the part to be manufactured is, for example, a ball joint, the moldable material may be selected from among any thermoplastics having favorable mechanical properties. More specifically, the moldable material may be selected from a polyamide, a polyoxymethylene, a polyether ether ketone, polyphenylene sulfide or other thermoplastics, metals or metal alloys known in the art.

Upon injection of a moldable material into the space(s) 22 defined around the insert, the moldable material may be permitted to solidify. In solidifying, the moldable material may be mechanically secured in position around one or more structures of the insert 20. Alternatively, the insert 20 may include one or more structural elements (for example a flange or the like) that operate to lock the solidified molded material into position.

Finally, after the moldable material has solidified, the mold body 12 may be unsealed and the insert 20 with the associated moldable portion removed for further manufacture or installation as required by the user.

Having thus described my invention, various other embodiments will become known to those of skill in the art that do not depart from the spirit of the present invention.

1. A method for an in -place molding operation comprising the steps of:
providing an insert;
providing a mold having first and second mold sections, the first and section defining a mold cavity, the mold cavity being operable to receive the insert,
positioning the insert in the mold cavity;
injecting a moldable material into the mold cavity, the moldable material being operable to solidify around the insert to form a molded portion;
removing the insert with associated mold portion from the mold cavity.
